(19) United States
(12) Patent Application Publication
(10) Pub. No.: US 2016/0341176 A1
(43) Pub. Date: Nov. 24, 2016

(54) CONNECTING ELEMENT FOR CONNECTING A BEARING DEVICE OF A ROTOR BLADE TO BE CONNECTED TO A ROTOR HUB OF A WIND TURBINE TO A MOUNTING FLANGE OF THE ROTOR HUB

(71) Applicant: SIEMENS AKTIENGESELLSCHAFT, München (DE)

(72) Inventor: MUJAHID SHAIK, SHANGHAI (CN)

(73) Assignee: SIEMENS AKTIENGESELLSCHAFT, München (DE)

(21) Appl. No.: 15/108,625

(22) PCT Filed: Nov. 11, 2014
(86) PCT No.: PCT/EP2014/074228

§ 371 Date: Jun. 28, 2016

(30) Foreign Application Priority Data
Feb. 11, 2014 (DE) 10 2014 202 459.5

(51) Int. Cl. F03D 1/06; F03D 80/70

(52) U.S. Cl. CPC F03D 1/0658; F03D 80/70

(57) ABSTRACT

A connecting element for connecting a bearing device, in particular a rolling bearing or plain bearing, of a rotor blade to be connected to a rotor hub of a wind turbine to a mounting flange of the rotor hub, wherein the connecting element has a first connecting region for connecting the connecting element to a mounting flange of a rotor hub of a wind turbine and a second connecting region for connecting the connecting element to a bearing device, in particular a rolling bearing or plain bearing, of a rotor blade to be connected to the or a rotor hub of a wind turbine, is provided.

### CROSS-REFERENCE TO RELATED APPLICATIONS

This application claims priority to PCT Application No. PCT/EP2014/074228, having a filing date of Nov. 11, 2014, based off of German application No. DE 102014202459.5 having a filing date of Feb. 11, 2014, the entire contents of which are hereby incorporated by reference.

### FIELD OF TECHNOLOGY

The following relates to a connecting element for connecting a bearing device, in particular a rolling-element or sliding bearing, of a rotor blade to be connected to a rotor hub of a wind turbine to a mounting flange of the rotor hub.

### BACKGROUND

The principal manner of connecting rotor blades to a rotor hub of a wind turbine is sufficiently well-known. To this end, typically a rotor-blade-side bearing device, such as a rolling-element bearing, is connected to a rotor-hub-side mounting flange by means of a suitable connecting element.

Considering the different dimensions of corresponding wind turbine types, i.e. in particular the different dimensions of corresponding, it has hitherto been necessary to provide tailor-made rotor hubs for each wind turbine type. Specifically, different rotor hubs have thus been provided for example for wind turbines producing 2.3 MW of power and having rotor blade lengths of approximately 100 m and for wind turbines producing 3 MW of power and having rotor blade lengths of approximately 110 m.

This is worthy of improvement in terms of manufacture, construction and economics.

### SUMMARY

An aspect relates to specifying a connecting element for a large number of different-sized wind turbines.

A further aspect relates to achieving a connecting element of the type mentioned in the introduction which is characterized, according to embodiments of the invention, in that the connecting element has a first connecting region for connecting the connecting element to a mounting flange of a rotor hub of a wind turbine and a second connecting region for connecting the connecting element to a bearing device, in particular a rolling-element or sliding bearing, of a rotor blade to be connected to the or a rotor hub of a wind turbine.

In general terms, the connecting element according to embodiments of the invention represent a mechanical connection between a mounting flange of a rotor hub of a wind turbine and a bearing device of a rotor blade. Accordingly, the connecting element according to embodiments of the invention serves, in the context of the affixing or securing of a corresponding rotor blade to a corresponding rotor hub, as a mechanical interface between a mounting flange of a rotor hub of a wind turbine and a bearing device of a rotor blade.

The connecting element according to embodiments of the invention have a first and a second connecting region. The connecting regions differ in terms of function in that they serve to connect the connecting element to different connection partners. The first connecting region serves to connect the connecting element to a rotor-hub-side mounting flange, and the second connecting region serves to connect the connecting element to a bearing device of a rotor blade. In that context, the bearing device can possibly already be connected to the rotor blade.

Such a bearing device is generally in the form of a rolling-element or sliding bearing, or a rolling-element or sliding bearing element, typically a bearing ring, or such a bearing device comprises at least one such rolling-element or sliding bearing, or one such rolling-element or sliding bearing element. As rolling-element bearings, ball bearings are particularly suitable.

The connecting-element-side connecting regions provided for different connection partners make it possible, by using the connecting element according to embodiments of the invention, to standardize the design of certain connection partners, i.e. to produce or provide these as standard components, and to connect these, by means of the connecting element according to embodiments of the invention, to connection partners which are not of standardized design. Specifically, this means that it is possible to provide, for example, rotor hubs which are of standardized design and which can be connected, by means of corresponding connecting elements, to bearing devices or rotor blades which are not of standardized design.

This has the production, design and economic advantage that different-sized wind turbines, i.e. in particular wind turbines which differ in terms of design in their rotor blade length, can be provided with a rotor hub of standardized design, i.e. in particular a rotor hub having a mounting flange of standardized design. This standard-design rotor hub can be connected, by means of the connecting element according to embodiments of the invention, to different bearing devices and thus to different rotor blades.

The connecting element is generally an annular component. Thus, the connecting element is typically annular. The annular shape is advantageous in particular with respect to the mechanical stability of the connecting element.

It is conceivable to divide the connecting element into multiple connecting element segments which are or can be connected to one another, forming the connecting element. With reference to the expedient annular shape of the connecting element, it is possible in that respect that the connecting element is divided into multiple ring segments which are or can be connected to one another, forming the or a ring. The segmentation of the connecting element is advantageous in particular with respect to handling and transport properties thereof. The first connecting region can have at least one first connecting section, which first connecting section has a number of holes, through each of which a connecting means can pass. The holes are distributed circumferentially on a circle of a given radius. Thus, the first connecting region can be formed in terms of design by at least one corresponding connecting section, which connecting section has a number of holes. Since the holes are, as mentioned, distributed circumferentially on a circle, the holes belonging to a corresponding first connecting section are thus on an imaginary circle (or circumference).

The holes are typically through-holes. The holes can have an internal thread.

It is possible for the first connecting region to have multiple first connecting sections. In this case, the respective first connecting sections differ in that the holes belonging to each of these are arranged on circles of different radii. Consequently, the holes belonging to a first connecting section are on a circle of smaller or larger diameter than the holes belonging to another first first connecting section.

The formation of a first connecting region with multiple first connecting sections can be advantageous since thus the connecting element according to embodiments of the invention can in that manner be connected to rotor hubs or rotor-hub-side mounting flanges of different design. This relates in particular to the conceivable case in which, for example as required by the manufacturer, instead of a single rotor hub being present, multiple standard-design rotor hubs are present. It is accordingly also possible that the second connecting region has at least one second connecting section, which second connecting section has a number of holes which are distributed circumferentially on a circle of a given radius, and through each of which a connecting means can pass. Thus, the second connecting region can also be formed in terms of design by at least one corresponding connecting section, which connecting section has a number of holes. The holes are again distributed circumferentially on a circle. Thus, the holes belonging to a corresponding second connecting section also lie on an imaginary circle.

The holes are also typically through-holes. The holes can also have an internal thread.

It is in that context also possible for the second connecting region to have multiple second connecting sections. In a similar manner, the respective second connecting sections differ in that the holes belonging to each of these are arranged on circles of different sizes. Consequently, the holes belonging to a first second connecting section are on a circle of smaller or larger diameter than the holes belonging to another second connecting section.

The formation of a second connecting region with multiple second connecting sections can be advantageous since thus the connecting element according to embodiments of the invention can in that manner be connected to a multiplicity of bearing devices of different design, i.e. in particular of different sizes, and thus to a multiplicity of different rotor blades, i.e. in particular of different sizes. In conjunction with the first and the second connecting sections, it is the case that the circle on which the holes belonging to the first connecting section are distributed circumferentially is larger or smaller than the circle on which the holes belonging to the second connecting section are distributed circumferentially. Even if the two configurations are in principle equal, it is generally provided that the circle on which the holes belonging to the second connecting section are arranged circumferentially is larger than the circle on which the holes belonging to the first connecting section are arranged circumferentially.

Embodiments of the invention also relate to an arrangement for connecting at least one bearing device, in particular a rolling-element bearing, of a rotor blade to a mounting flange of a rotor hub of a wind turbine. The arrangement comprises a rotor hub having at least one mounting flange and at least one connecting element according to embodiments of the invention, as described above. Accordingly, with regard to the arrangement according to the invention, all embodiments with respect to the connecting element according to the invention apply in a similar manner.

As a refinement of the arrangement, it is thus possible that the first connecting region has at least one first connecting section, which first connecting section has a number of holes which are distributed circumferentially on a circle of a given radius, and through each of which a connecting means can pass.

With regard to the actual mechanical connection of the connecting element to the respective connection partners, it is expedient in that context if first connecting means are assigned to the holes of the first connecting section for the purpose of connecting the connecting element to the rotor-hub-side mounting flange and to the holes of the second connecting section for the purpose of connecting the connecting element to a rotor-blade-side bearing device. The respective connecting means are typically screws, bolts, etc.

It is of course possible, in order to establish a mechanically stable connection between the connecting element and the respective connection partners, for additional connecting means, typically corresponding to the connecting-element-side connecting means, such as tapped holes, nuts, etc. to be necessary. The additional connecting means can be provided on the respective connection partners.

In addition to the connecting element and the arrangement, embodiments of the invention also relates to a wind turbine comprising at least one rotor blade having at least one bearing device, in particular a rolling-element or sliding bearing, and at least one arrangement according to embodiments of the invention, as described above. The wind turbine is characterized in that the bearing device is connected to the mounting flange of the rotor hub by means of at least one connecting element. Accordingly, with respect to the wind turbine according to the invention, all of the embodiments relating to the arrangement according to the invention and relating to the connecting element according to embodiments of the invention apply in a similar manner.

### BRIEF DESCRIPTION

Some of the embodiments will be described in detail, with reference to the following figures, where like designations denote like members, wherein:

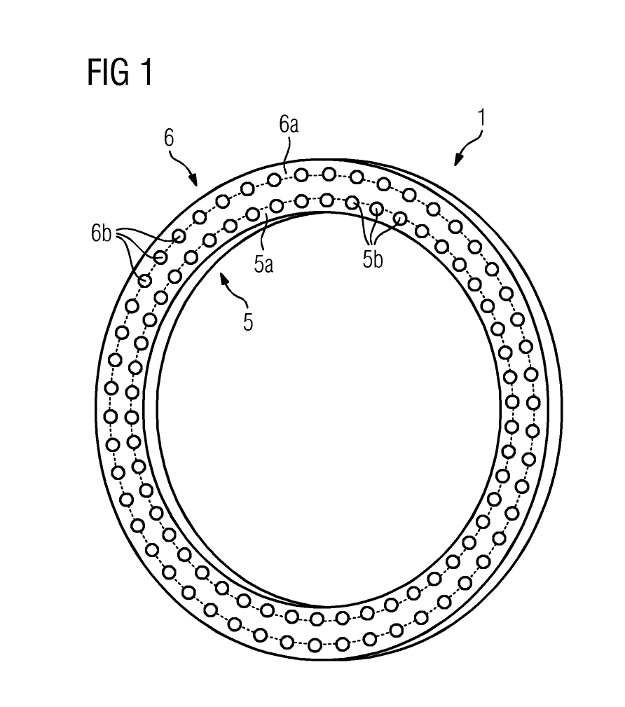

FIG. 1 shows an embodiment of a connecting element;

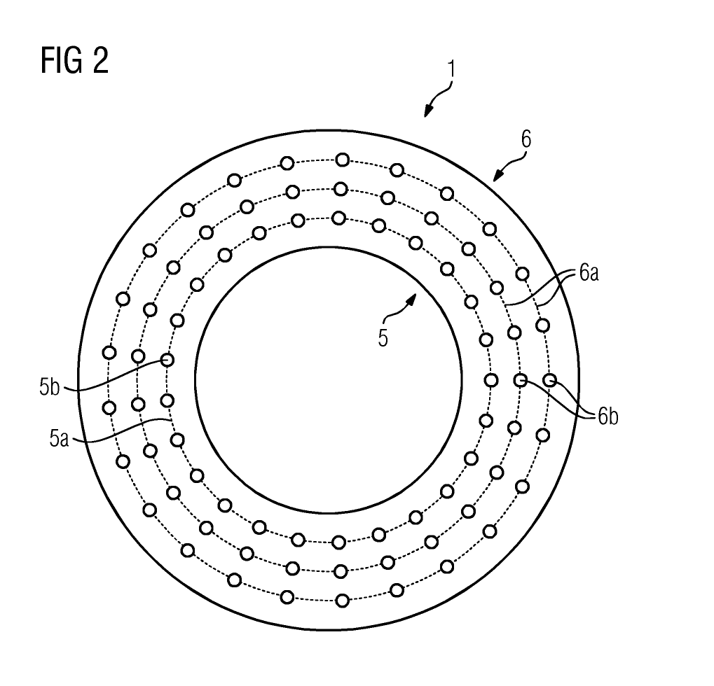

FIG. 2 shows another embodiment of a connecting element; and

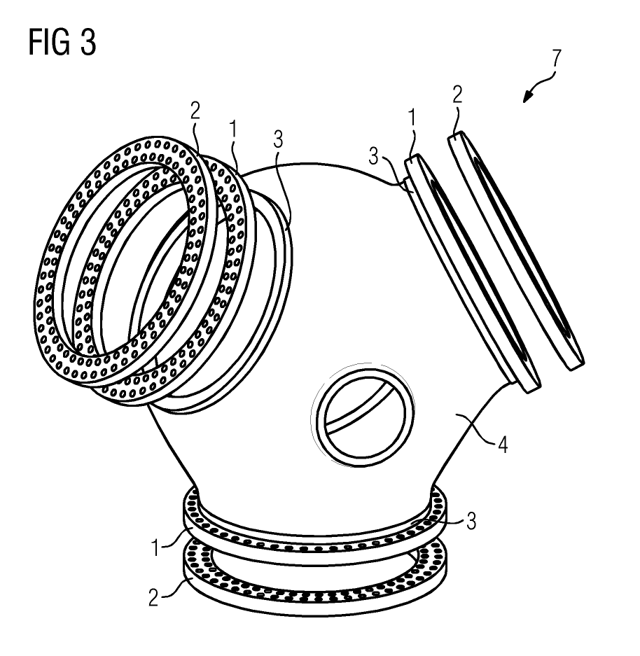

FIG. 3 shows an embodiment of an arrangement having multiple connecting elements.

### DETAILED DESCRIPTION

FIG. 1 shows a connecting element 1 according to one exemplary embodiment of the invention. The connecting element 1 serves for connecting a bearing device 2, such as a rolling-element bearing, of a rotor blade (not shown) to a mounting flange 3 of a rotor hub 4 of a wind turbine (not shown).

As can be seen, the connecting element 1 is an annular component made of a metallic material, in particular a steel. Although not shown in the Figures, it is possible for the connecting element 1 to be divided into multiple ring segments which can be connected to one another, forming the ring.

The connecting element 1 has a first connecting region 5 and a second connecting region 6. The connecting regions 5, 6 differ in terms of function in that they serve to connect the connecting element 1 to different connection partners. The first connecting region 5 serves to connect the connecting element 1 to a mounting flange 3 of a rotor hub 4, and the second connecting region 6 serves to connect the connecting element 1 to a bearing device 2 of a rotor blade.

By virtue of the connecting regions 5, 6 provided for different connection partners, the connecting element 1 according to embodiments of the invention makes it possible to standardize the design of certain connection partners, i.e. to produce or provide these as standard components, and to connect these to connection partners which are not of standardized design. Consequently, it is possible to provide rotor hubs of such standardized design which can be connected, by means of corresponding connecting elements 1, to bearing devices 2 or rotor blades which are not of standardized design.

The respective connecting regions 5, 6 each comprise connecting sections 5a, 6a. In that context, a first connecting section 5a belongs to the first connecting region 5, and a second connecting section 6a belongs to the second connecting region 6. The respective connecting sections 5a, 6a each have a number of holes 5b, 6b.

As can be seen, the holes 5b, 6b are in each case distributed circumferentially on a circle of a given radius. Accordingly, the holes 5b, 6b belonging in each case to a corresponding connecting section 5a, 6a lie on an imaginary circle (or circumference). The respective circumferences are indicated in FIG. 1 by dotted lines, purely for reasons of clarity.

The holes 5b, 6b are in each case through-holes which may have an internal thread. Consequently, a connecting means (not shown) such as a bolt can pass through each of the holes 5b, 6b.

As can be seen, the holes 6b belonging to the second connecting section 6a are arranged on a circle of relatively larger diameter or radius. Accordingly, the holes 6b belonging to the second connecting section 6a lie radially further out, considered in relation to the center of symmetry of the connecting element 1, than the holes 5b belonging to the first connecting section 5a.

With reference to FIG. 2, which shows a connecting element 1 according to another exemplary embodiment of the invention, it can be seen that the second connecting region 6 can also have multiple second connecting sections 6a. The respective second connecting sections 6a differ in that the holes 6b belonging to each of these are arranged on circles of different diameters or radii.

The holes 6b belonging to a second connecting section 6a which is radially further inward lie on a circle of smaller diameter than the holes 6b belonging to a second connecting section 6a which is radially further outward.

The formation of a second connecting region 6 with multiple second connecting sections 6a can be advantageous since thus the connecting element 1 according to embodiments of the invention can in that manner be connected to a multiplicity of bearing devices 2 of different sizes, and thus to a multiplicity of rotor blades of different sizes.

Similarly, it is of course also possible for the first connecting region 5 to have multiple first connecting sections 5a.

FIG. 3 shows an arrangement 7 having multiple connecting elements 1, according to one exemplary embodiment of the invention. As can be seen, it is an exploded view.

The arrangement 7 serves for connecting bearing devices 2 of respective rotor blades to respective mounting flanges 3 of a rotor hub 4 of a wind turbine. Accordingly, the arrangement 7 comprises a rotor hub 4 having a number of mounting flanges 3, and a number, corresponding to the number of rotor-hub-side mounting flanges 3, of connecting elements 1.

As already set out in relation to FIGS. 1, 2, the first and second connecting regions 5, 6 each have a number of holes 5b, 6b, through each of which one connecting means (not shown), such as a bolt, can pass. The holes 5b, 6b are in each case distributed circumferentially on a circle of a given radius.

In the context of the arrangement 7, first connecting means, as mentioned in particular bolts, are assigned to the holes 5b of the first connecting region 5 for the purpose of connecting the connecting element 1 to a rotor-hub-side mounting flange 3. In corresponding fashion, corresponding connecting means are assigned to the holes 6b of the second connecting region 6 for the purpose of connecting the connecting element 1 to a rotor-blade-side bearing device 2.

In the exemplary embodiments shown in the Figures, the second connecting region 6 is connected to the rotor-blade-side bearing device 2 in each case via the bearing inner ring.

Typically, in order to establish a mechanically stable connection between the connecting elements 1 and the respective connection partners, additional connecting means, typically corresponding to the connecting-element-side connecting means, such as tapped holes, nuts, etc. are necessary.

With reference to the rotor hub 4, it is also to be mentioned that this of course has another mounting flange which is not shown in greater detail in FIG. 3 and which permits attachment to a wind turbine, i.e. in particular to a machine house located on a wind-turbine-side tower construction.

Although the invention has been described and illustrated in more detail by way of the preferred exemplary embodiment, the invention is not restricted by the disclosed examples and other variations can be derived herefrom by a person skilled in the art without departing from the scope of protection of the invention.

1. A connecting element for connecting a bearing device of a rotor blade to be connected to a rotor hub of a wind turbine to a mounting flange of the rotor hub, the connecting element comprising:
a first connecting region for connecting the connecting element to the mounting flange of the rotor hub of the wind turbine; and
a second connecting region for connecting the connecting element to the bearing device of the rotor blade to be connected to the rotor hub of the wind turbine.

2. The connecting element as claimed in claim 1, wherein the connecting element is in a form of a ring.

3. The connecting element as claimed in claim 2, wherein the connecting element is divided into a plurality of ring segments which are connected to one another, forming the ring.

4. The connecting element as claimed in claim 1, wherein the first connecting region has at least one first connecting section, the at least one first connecting section having a number of holes which are distributed circumferentially on a circle of a given radius, and through each of which a connecting means can pass.

5. The connecting element as claimed in claim 1, wherein the second connecting region has at least one second connecting section, the at least one second connecting section having a number of holes which are distributed circumferentially on a circle of a given radius, and through each of which a connecting means can pass.

6. The connecting element as claimed in claim 4, wherein the circle on which the number of holes belonging to the at least one first connecting section are distributed circumferentially is larger or smaller than the circle on which the number of holes belonging to the at least one second connecting section are distributed circumferentially.

7. An arrangement for connecting at least one bearing device, of a rotor blade to a mounting flange of a rotor hub of a wind turbine, comprising a rotor hub having at least one mounting flange and at least one connecting element as claimed in claim 1.

8. The arrangement as claimed in claim 7, wherein the first connecting region has at least one first connecting section, the at least one first connecting section having a number of holes which are distributed circumferentially on a circle of a given radius, and through each of which a connecting means can pass, wherein first connecting means, are assigned to the number of holes of the at least one first connecting region for the purpose of connecting the connecting element to the rotor-hub-side mounting flange and bolts are assigned to the number of holes of the second connecting region for the purpose of connecting the connecting element to the rotor-blade-side bearing device.

9. A wind turbine, comprising at least one rotor blade having at least one bearing device, and at least one arrangement as claimed in claim 7, wherein the at least one bearing device is connected to the mounting flange of the rotor hub by means of at least one connecting element.

10. The connecting element as claimed in claim 1, wherein the bearing device is at least one of a rolling element and a sliding bearing.

11. The arrangement as claimed in claim 7, wherein the bearing device is at least one of a rolling element and a sliding bearing.

12. The wind turbine as claimed in claim 9, wherein the at least one bearing device is at least one of a rolling element and a sliding bearing.
